(19) United States
(12) Patent Application Publication
(10) Pub. No.: US 2005/0098667 A1
(43) Pub. Date: May 12, 2005

(54) Universal flexible powder coating tip/nozzle

(76) Inventor: Jeffrey David Sawczyszyn, Canisteo, NY (US)

Correspondence Address: Jeffrey David Sawczyszyn, 3 Spruce Street, Canisteo, NY, 14823, US

(21) Appl. No.: 10/909,830

(22) Filed: Nov. 23, 2004

Related U.S. Application Data
(60) Provisional application No. 60/492,270, filed on Aug. 4, 2003.

(51) Int. Cl. B05B 5/00

(52) U.S. Cl. 239/690; 239/690.1

(57) ABSTRACT

This Universal Flexible Powder Coating Tip/Nozzle will greatly enhance the application of Powder Coating coverage in hard to reach area's do to the ability to bend the flexible tip/nozzle to reach into those difficult to reach area's. The Powder Coater will no longer have to try to angle a large cumbersome powder Coating gun into tight corners and openings, he only needs to insert the Universal Flexible Powder Coating Tip/Nozzle into these hard to reach area's and bend and turn for proper angle. The uncharged Powder will flow down the flexible tip/nozzle and receive charging as it travels past the contact at the powder tip.

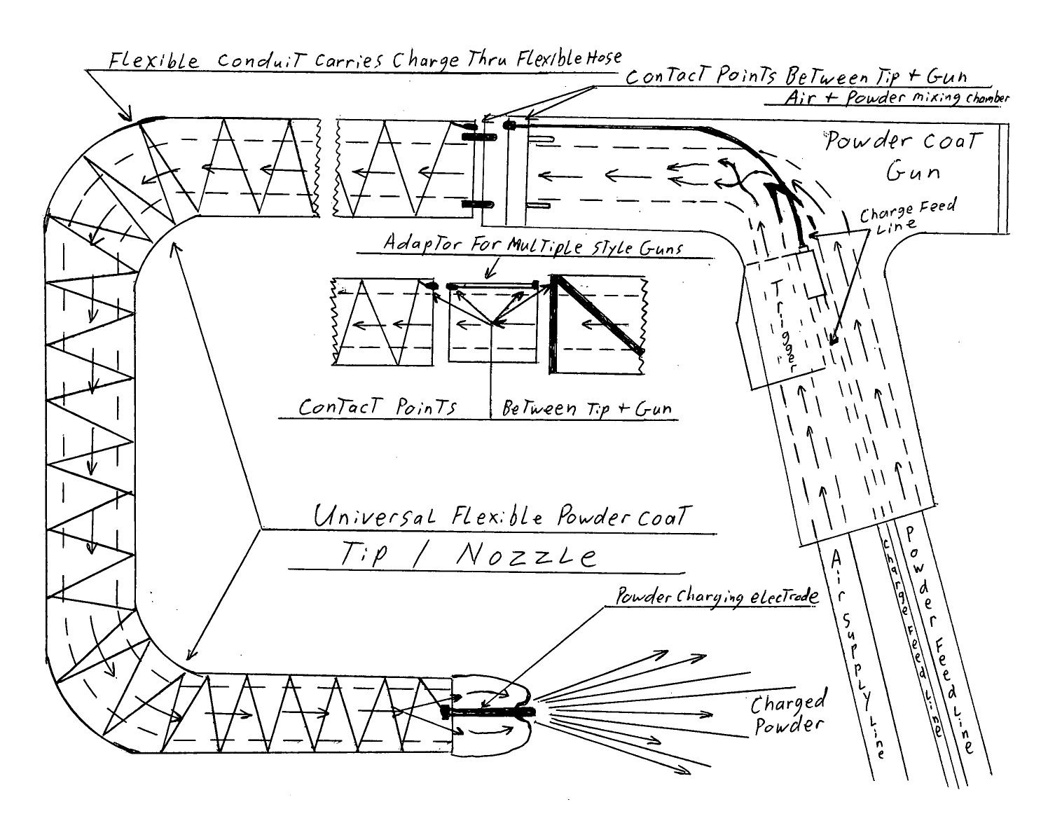

### GENERAL

a) This specification pertains to a Provisional Patent application No. 60/492,270, Conf # 3498 and the Invention that I have made to enhance the application of Powder Coating in virtually all venues, and for virtually all applications especially hard to reach places that are extremely difficult to fit a powder coat gun. This invention will greatly enhance productivity and virtually eliminate recoating do to lack of coverage

b) This flexible wand is made out of a smooth flexible non-stick hose that has a spring running the full length inside, from the contact point on the existing powder coat gun to the contact (charge electrode) at the tip. The spring will be inlayed under a layer of non-stick material as to not promote powder build up inside the “Flexible Powder Coating Tip/Nozzle”.

c) This flexible hose and spring are combined to give you maximized flexibility for getting to those hard to reach areas that are the most problematic when it comes to Powder Coating. Also as a result of the spring running the full length of the hose, it provides reinforcement so that when the hose is bent it does not collapse and cause catastrophic results in your powdered components finish. * Note the spring serves not only as the conductor between the gun and the tip, but also as the reinforcement for the hose.

d) The flexible Powder Coating Tip/Nozzle will be universal, in that through the use of adaptors will fit almost any powder coating gun and or application currently in production. There will also be multiple length tips ranging from 12 to 24 to 36 inches long. Also there will be multiple diameter “Flexible Powder Coating Tips/Nozzles”, combined with multiple gun adaptors will make this invention a universal fit for the Powder Coating Industry.

1) I Jeffrey David Sawczyszyn do claim that the combination of this Flexible non stick hose material and the full length spring conductor inlaid inside of the non stick hose, in conjunction with the contact points were the Flexible Hose (Nozzle) attaches to Powder Coating Gun and at the Application End (Tip) for powder charging purposes, is solely my invention and design. This combination allows the Powder and the charge to travel from the gun, through the flexible Nozzle (Hose) and spring conductor, to the application end (tip) and charge contact thus charging the powder as it exit's the tip.

2) Furthermore I claim that this Universal Flexible Powder Coating Tip/Nozzle combination can by use of adaptors, fit almost any Powder Coating Gun Application.
